(19) United States
(12) Patent Application Publication
(10) Pub. No.: US 2016/0230934 A1
(43) Pub. Date: Aug. 11, 2016

(54) Method for Storing a Pressurized Liquid or Gas in a Portable Storage Tank

(71) Applicant: FB Industries Inc., Winkler (CA)

(72) Inventors: Henry Friesen, Winkler (CA); Peter Friesen, Winkler (CA)

(21) Appl. No.: 14/615,074

(22) Filed: Feb. 5, 2015

(51) Int. Cl. F17C 13/08; F17C 5/06; F17C 5/02

(52) U.S. Cl. CPC F17C 13/081; F17C 5/02; F17C 5/06; F17C 2205/0161; F17C 2227/04; F17C 2225/013; F17C 2225/0123; F17C 2223/013; F17C 2223/0123; F17C 2270/0168

(57) ABSTRACT

A method for storing a pressurized liquid or gas features a portable storage tank arranged to contain liquids or gases under pressure therein. The tank has a tank body with openings at or adjacent the top and bottom of the tank body for filling the liquid or gas therein and discharging the liquid or gas therefrom. Also, the tank has a support assembly for resting on a support surface that is arranged to hold the tank body raised above the ground. The support assembly includes a plurality of legs extending downwardly from the tank body and a base arranged for resting on the ground to support the tank standing upwardly from the ground. The method further comprises loading the tank in a substantially horizontal position onto a trailer for transporting the tank; erecting the tank; and filling the pressurized liquid or gas into the tank.

### FIELD OF THE INVENTION

The present invention relates generally to a method for storing a pressurized liquid or gas, and more particularly the present invention relates to a method for storing a pressurized liquid or gas that involves a portable storage tank which is portable on a trailer.

### BACKGROUND

Storage of gases is challenging for industries as the gases generally have large volumes. The gases may be liquefied and/or pressurized prior to storing for reducing the volume of the gases so that the storage of the gases is feasible.

The storage of the gas may involve filling the gas into a tank or vessel. One potential shortcoming of using the tank or vessel may be that the tank or vessel often occupies a large amount of space. Another potential shortcoming may be that the tank or vessel is not readily portable for relocating the tank or vessel, which may be desirable for applications in which the gas is stored temporarily at a particular location.

The Applicant provides a unique solution for storing pressurized liquids or gases.

### SUMMARY OF THE INVENTION

According to one aspect of the invention there is provided a method for storing a pressurized liquid or gas comprising:
arranging a portable storage tank for storing the pressurized liquid or gas therein, the portable storage tank comprising:
   a tank body arranged to contain pressurized liquids or gases therein, the tank body having a periphery wall defining a circular outer periphery of the tank, an upper wall at a top of the tank, and a lower wall at a bottom of the tank;
   openings at or adjacent the top and bottom of the tank body for filling said liquid or gas therein and discharging said liquid or gas therefrom, the openings being arranged to contain the pressurized liquid or gas within the tank body;
   a support assembly for resting on a support surface, the support assembly being arranged such that respective ones of the openings at or adjacent the bottom of the tank body are raised relative to the support surface for discharge into a receptacle at the support surface;
   the support assembly including a plurality of legs extending downwardly from the tank body;
   the support assembly further including a base arranged for resting on the support surface to support the tank body standing upwardly from the support surface;
loading the portable storage tank in a substantially horizontal position onto a trailer for transporting the portable storage tank;
erecting the portable storage tank; and
filling the pressurized liquid or gas into the portable storage tank.

The embodiment as described in more detail hereinafter provides a tank body arranged to store a pressurized liquid or gas therein, the tank body being part of a portable storage tank designed to be portable and stably supported on uneven support surfaces against tilting. The tank body stands upwardly so that the portable storage tank occupies minimal space when erected.

Preferably, the portable storage tank further comprises a plurality of handles at the periphery wall that are arranged to be hooked cooperatively with the trailer for securing the tank body to the trailer during transportation and when loading and erecting the tank body. Preferably, the handles are coupled to an outer surface of the periphery wall, In one instance, the handles are welded to the outer surface of the periphery wall.

Preferably, the trailer comprises a bed portion arranged to support the portable storage tank thereon, the bed portion also being arranged to be movable between a transport position in which the bed portion is substantially horizontal and an erecting position in which the bed portion is substantially vertical. It is preferred that the bed portion is arranged for pivotal movement between the transport and erecting positions that is about an axis transverse to a longitudinal axis of the trailer.

When the trailer comprises the bed portion, the bed portion preferably further comprises a plurality of arms arranged to be cooperatively hooked with the tank body for attaching the tank body to the bed portion.

Preferably, the base has openings along at least a portion of an outer periphery of the base that are arranged to be cooperatively interlocked with the trailer for loading and erecting the tank body. It is preferred that said at least a portion of the outer periphery of the base comprises transversely opposing sides of the outer periphery of the base and the openings therein are generally rectangular. Preferably, the trailer has protruding elements at a rear thereof that are arranged to be inserted into the openings of the base of the portable storage tank. Preferably, at least one of the protruding elements comprises a base engaging surface arranged to press on the base generally upwardly from within one of the openings of the base.

Preferably, the support assembly includes at least four stabilizer arms located at spaced positions about the base, each stabilizer arm being movable between a first retracted position in which said each stabilizer arm is located inside the circular outer periphery for transport with the tank body and a second extended position in which said each stabilizer arm extends outwardly to a respective side of the base for engaging the support surface outwardly of the base while the base sits on the support surface for stabilizing the base against tilting. In one instance, each stabilizer arm is movable between the first retracted and second extended positions about an upstanding axis defined by each leg. In another instance, each stabilizer arm is movable between the first retracted and second extended positions about a horizontal axis. Preferably, each stabilizer arm comprises at least two sections which are foldable at an elbow of said each stabilizer arm that joins said at least two sections, the elbow allowing the sections to be folded thereat about an upstanding axis. Preferably, each one of the at least two sections of said each stabilizer arm has a section length, the section length of at least one of the at least two sections being less than a spacing between adjacent legs along a periphery of the base. In one instance, the stabilizer arms are connected to the legs. In another instance, the stabilizer arms are connected to the base.

Preferably, the circular outer periphery has an outer diameter less than 15 feet so as to allow the tank body to be portable on the trailer.

Preferably, the tank body is cylindrical along its full length.

Preferably, each leg has a main portion and a mounting portion thereunder, the mounting portion extending radially beyond the main portion. In one instance, the mounting portions of the legs are bolted to the base. In another instance, the mounting portions are welded to the base. Preferably, each leg is cylindrical along a majority of its length.

### BRIEF DESCRIPTION OF THE DRAWINGS

One embodiment of the invention will now be described in conjunction with the accompanying drawings in which:

FIG. 1 is a front perspective view of the portable storage tank on the bed portion of the trailer that is in the transport position.

FIG. 2 is a front perspective view of the portable storage tank in FIG. 1 with the bed portion in an intermediate position thereof.

FIG. 3 is a front perspective view of the portable storage tank in FIG. 1 with the bed portion in the erecting position.

FIG. 3a is a perspective view of grapples arms of the bed portion hooked onto handles of the portable storage tank as encircled in FIG. 3.

FIG. 4 is a side elevation view of the portable storage tank in FIG. 1.

FIG. 5 is a side elevation view of the portable storage tank in FIG. 2.

FIG. 6 is a side elevation view of the portable storage tank in FIG. 3 with stabilizer arms in the first retracted position.

FIG. 6a is a schematic view of the protruding elements of the bed portion inserted in the openings along the base.

FIG. 7 is a side elevation view of the portable storage tank separated from the bed portion of the trailer with the stabilizer arms in the second extended position.

FIG. 8 is a top plan view of the portable storage tank in FIG. 7.

FIG. 9 is a perspective view of an embodiment of the stabilizer arms in which the stabilizer arms are hydraulically actuated, and the stabilizer arms are in the first retracted position.

FIG. 10 is a perspective view of the embodiment of the stabilizer arms in FIG. 9 with the stabilizer arms in the second extended position.

FIG. 11 is a perspective view of an embodiment of the stabilizer arms in which the stabilizer arms are manually actuated, and the stabilizer arms are in the first retracted position.

FIG. 12 is a perspective view of the embodiment of the stabilizer arms in FIG. 11 with the stabilizer arms in the second extended position.

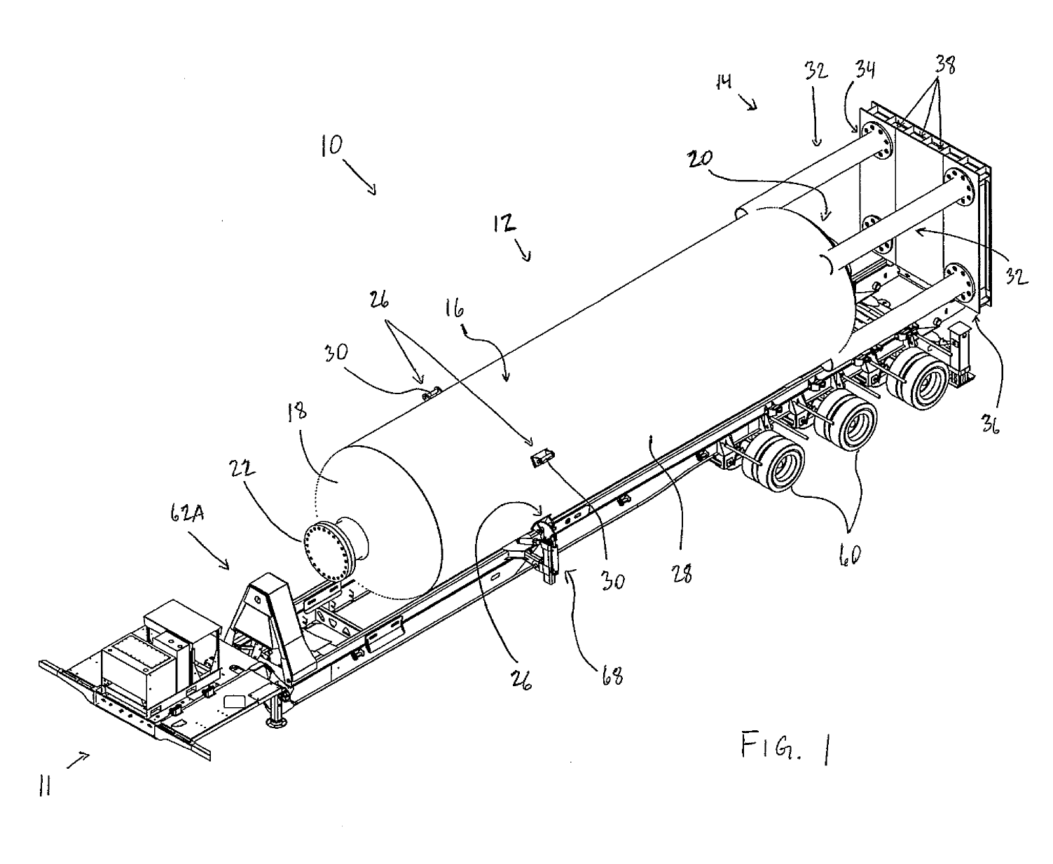

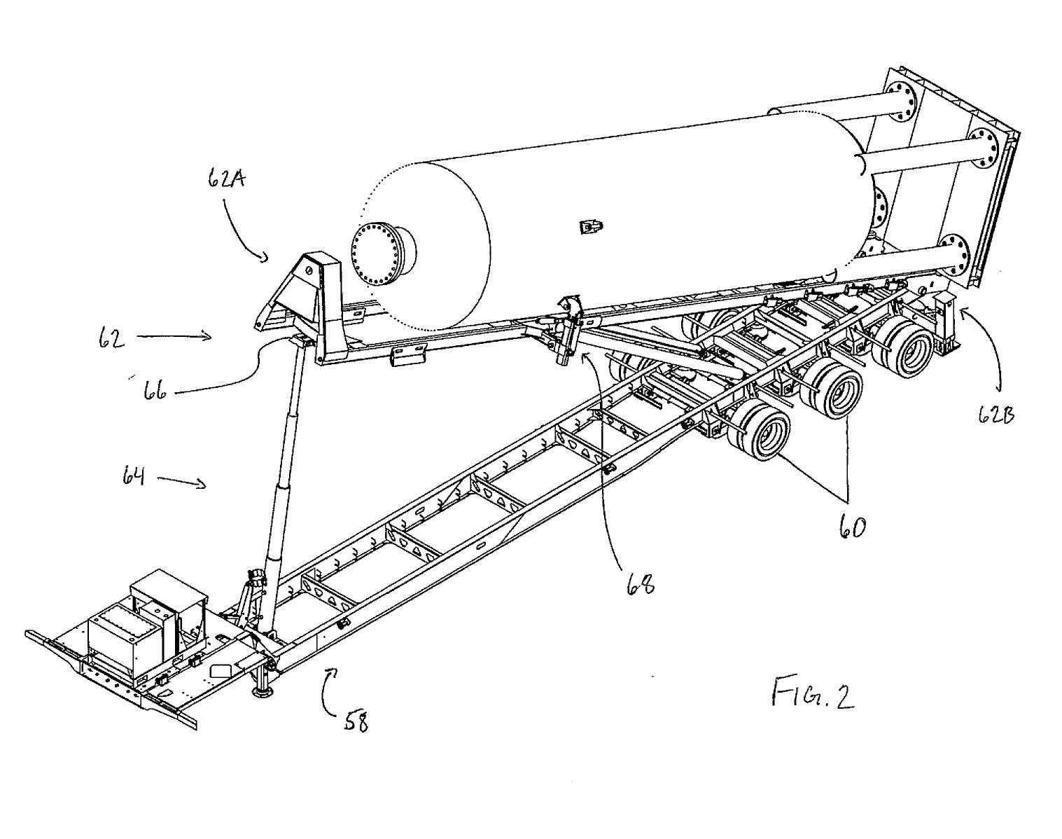

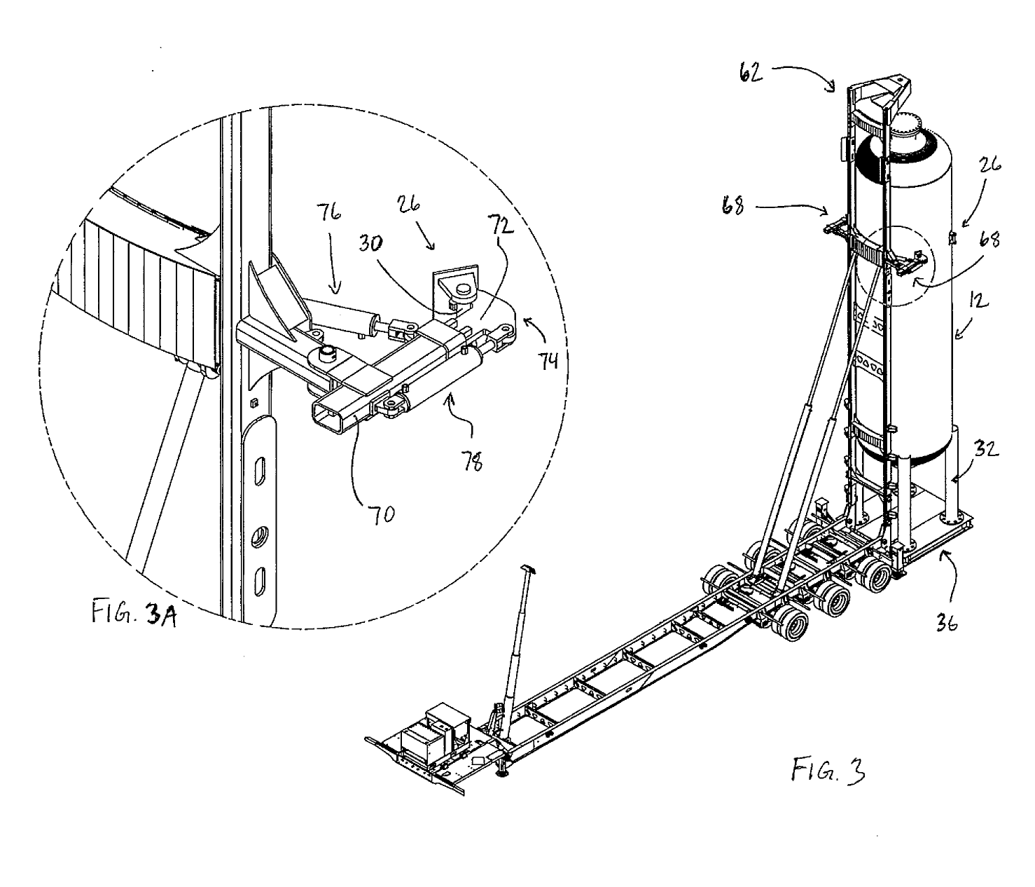

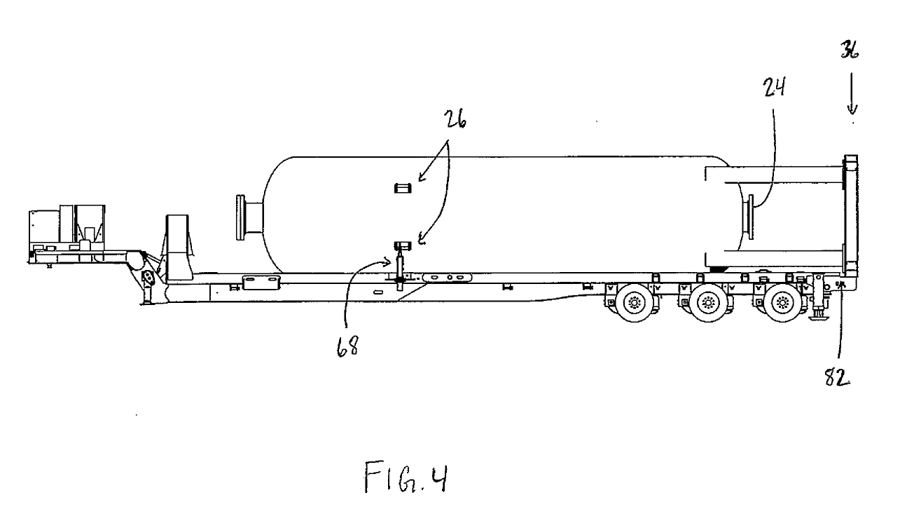

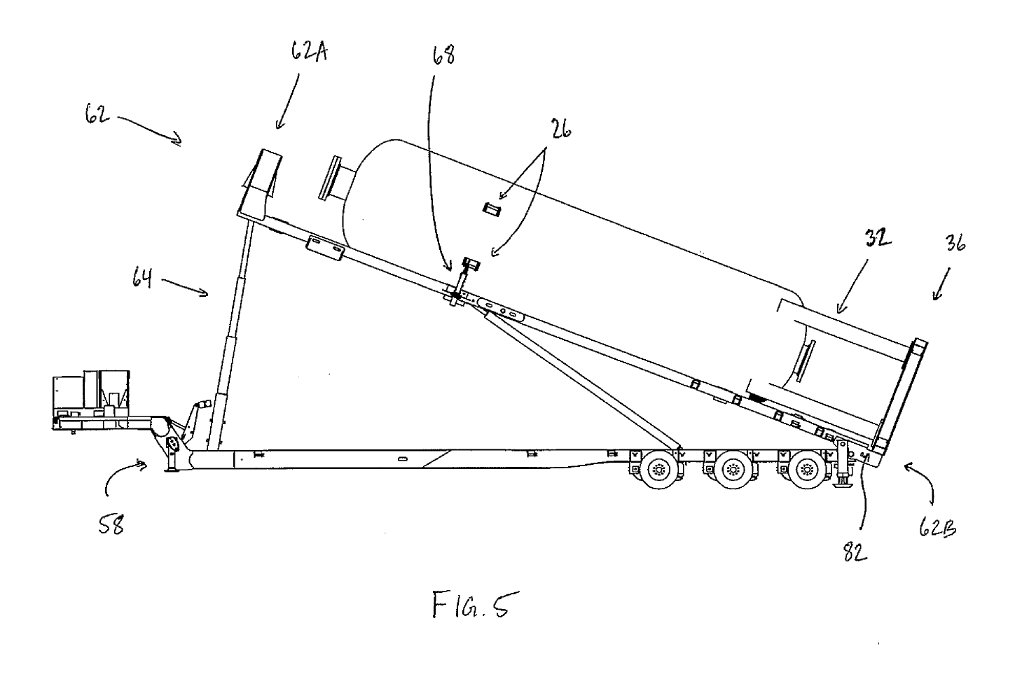

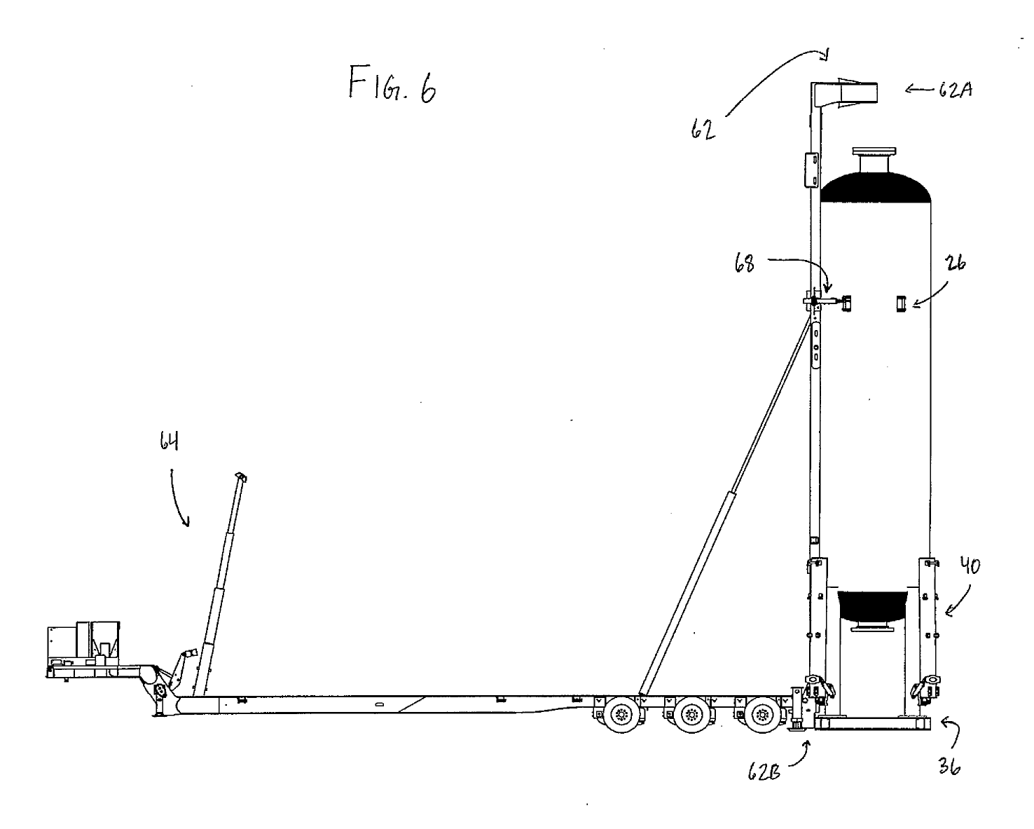

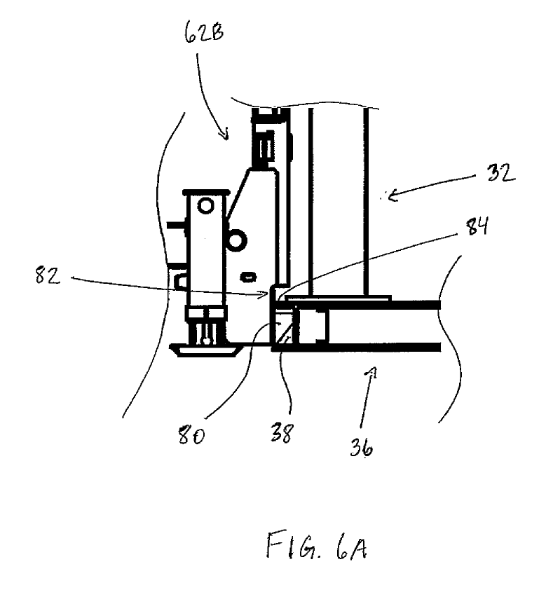

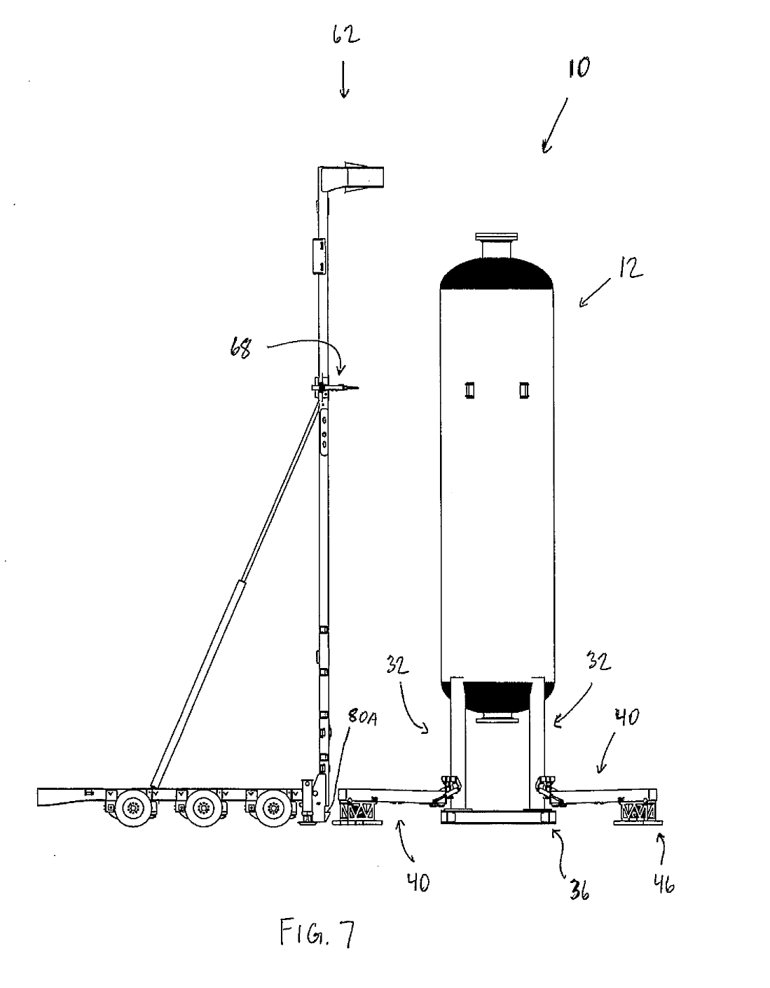

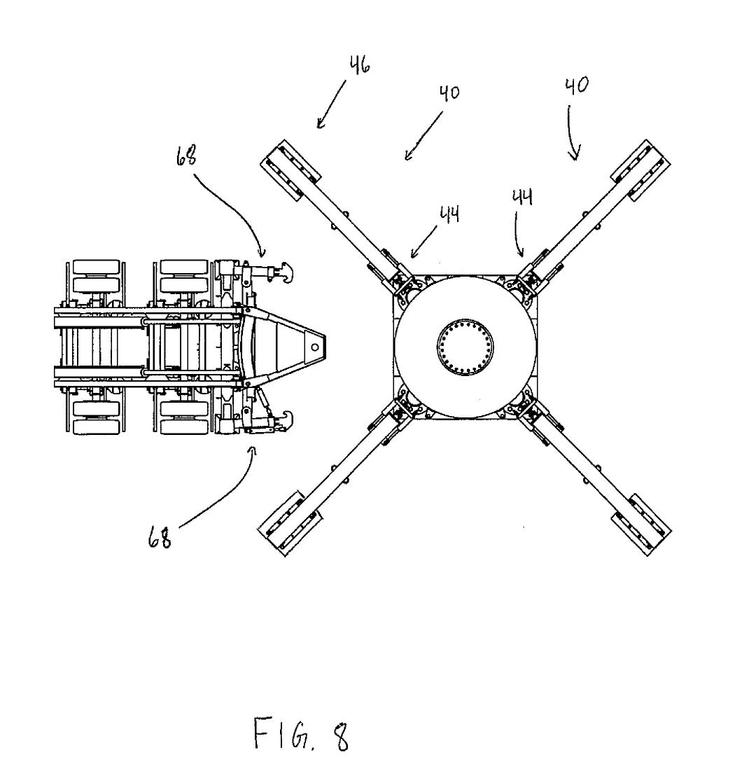

In the drawings like characters of reference indicate corresponding parts in the different figures.

### DETAILED DESCRIPTION

Referring to the accompanying figures, there is illustrated a portable storage tank indicated by reference numeral 10. The portable storage tank is used for storing a pressurized liquid or gas. The portable storage tank is portable by trailer 11.

The portable storage tank generally comprises a tank body 12 arranged to contain pressurized liquids or gases therein. As such, in the illustrated embodiment the tank body defines a pressure vessel for containing the pressurized liquids or gases therein that is closed. The portable storage tank also includes a support assembly 14 for resting on a ground surface or generally on a support surface.

Turning now to the tank body in more detail, the tank body has a periphery wall 16 defining a circular outer periphery of the tank body. The circular outer periphery of the tank body surrounds a longitudinal axis of the tank body. The circular outer periphery has an outer diameter of 8 feet; in other embodiments, the circular outer periphery may be less than 15 feet so as to allow the tank body to be portable on the trailer 11. The tank body is cylindrical along its full length and is longitudinally elongate. An outer surface of the periphery wall is smooth along a full circumference and full longitudinal length of the periphery wall. The tank body also has an upper wall 18 at a top of the tank body and a lower wall 20 at a bottom of the tank body. Both the upper and lower walls are domed. Furthermore, the portable storage tank has a filling opening 22 which is at an uppermost peak of the upper wall for filling the pressurized liquids or gases therein. In addition, the portable storage tank includes a discharge opening 24 which is at a lowermost peak of the lower wall for discharging the liquids or gases therefrom. The filling and discharge openings are arranged to contain the pressurized liquid or gas within the tank body.

The portable storage tank includes a plurality of handles 26 at the periphery wall of the tank body. The handles are at spaced locations about the periphery wall for securing the portable storage tank to the trailer during transportation and when loading and erecting the portable storage tank. The handles lie in a radial plane of the longitudinal axis of the tank body that is closer to the upper wall than to the lower wall of the tank body. The handles are generally U-shaped. Furthermore, the handles are welded to an outer surface 28 of the periphery wall so as to project radially outwardly from the outer surface thereof. Gripping elements 30 of the handle are elongate bars which are substantially parallel to the longitudinal axis of the tank body. The gripping elements are oriented substantially upright when the tank body is standing upwardly; in addition, the gripping elements are spaced outwardly away from the periphery wall.

Turning now to the support assembly, the support assembly 14 is arranged such that the discharge opening 24 of the tank body is raised relative to the support surface for discharge into a receptacle at the support surface. As such, the support assembly comprises a plurality of legs 32 extending downwardly from the tank body. The legs of the support assembly meet the periphery wall 16 at a bottom thereof. Each leg is cylindrical along a majority of its length. Generally speaking, each leg is offset from the tank body such that a longitudinal axis of each leg is substantially aligned with the circular outer periphery of the tank body such that the longitudinal axis of each leg intersects the circular outer periphery at a right angle relative thereto. As such, a portion of each leg extends radially outward beyond the periphery wall. Furthermore, each leg has a mounting portion 34 at a bottom thereof. The mounting portion extends radially from the leg and is substantially disc shaped. Overall, the legs are designed such that an entirety of the portable storage tank, including the tank body and support assembly, meet size requirements of transport by trailer so that the portable storage tank is portable on the trailer.

The support assembly also includes a base 36 below the legs that is arranged for resting on the ground surface to support the tank body standing upwardly from the ground surface. The base is fixed relative to the tank body so that the base is fixed in a radial plane of the longitudinal axis of the tank body that is below the radial plane in which the handles lie. The base defines an outer peripheral edge with transverse dimensions in all directions transverse to the longitudinal axis of the tank body that are substantially equal to the diameter of the circular outer periphery and so that the base is also transportable with the tank body. Furthermore, in the illustrated embodiment the tank body has a height from the base that is 45 feet. In other embodiments, the height of the tank body from the base may be between 30 and 45 feet.

The base 36 is generally square in plan view as in the illustrated embodiment. The base has a top surface on which the legs 32 are supported. More particularly, in the illustrated embodiment the legs are welded to the base at the mounting portions 34 of the legs. In other embodiments, the legs may be bolted to the base. Furthermore, the base has a bottom surface for engaging the ground surface. The base also has side walls spanning between the top and bottom surfaces along peripheries thereof. (The side walls also lie generally along an outer periphery of the base). The base has openings 38 in transversely opposing side walls which are arranged to be cooperatively interlocked with the trailer for loading and erecting the portable storage tank. The openings are generally rectangular and spaced along the transversely opposing side walls.

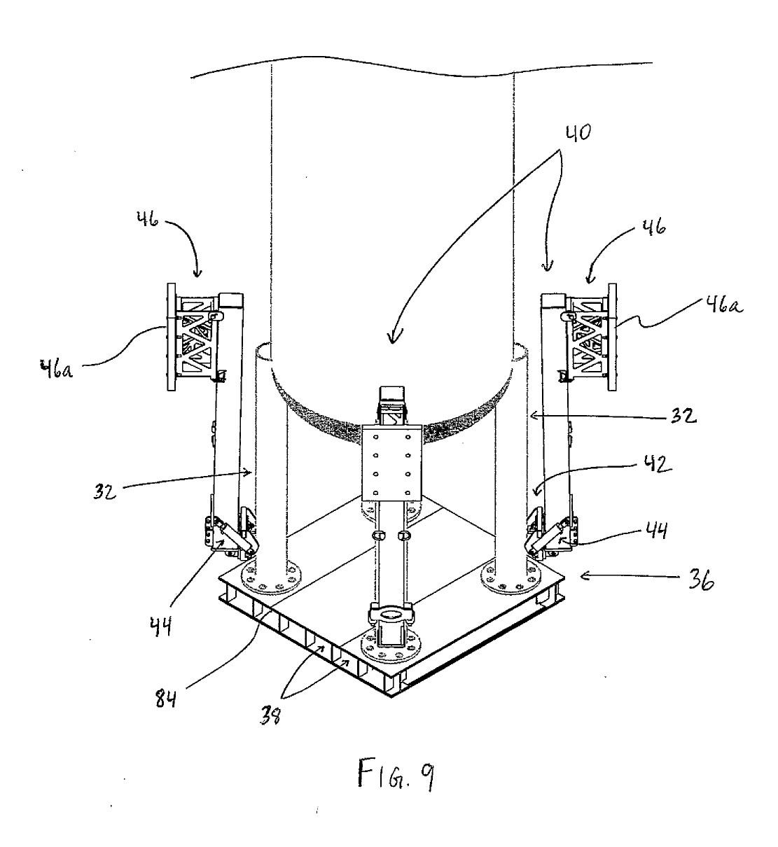

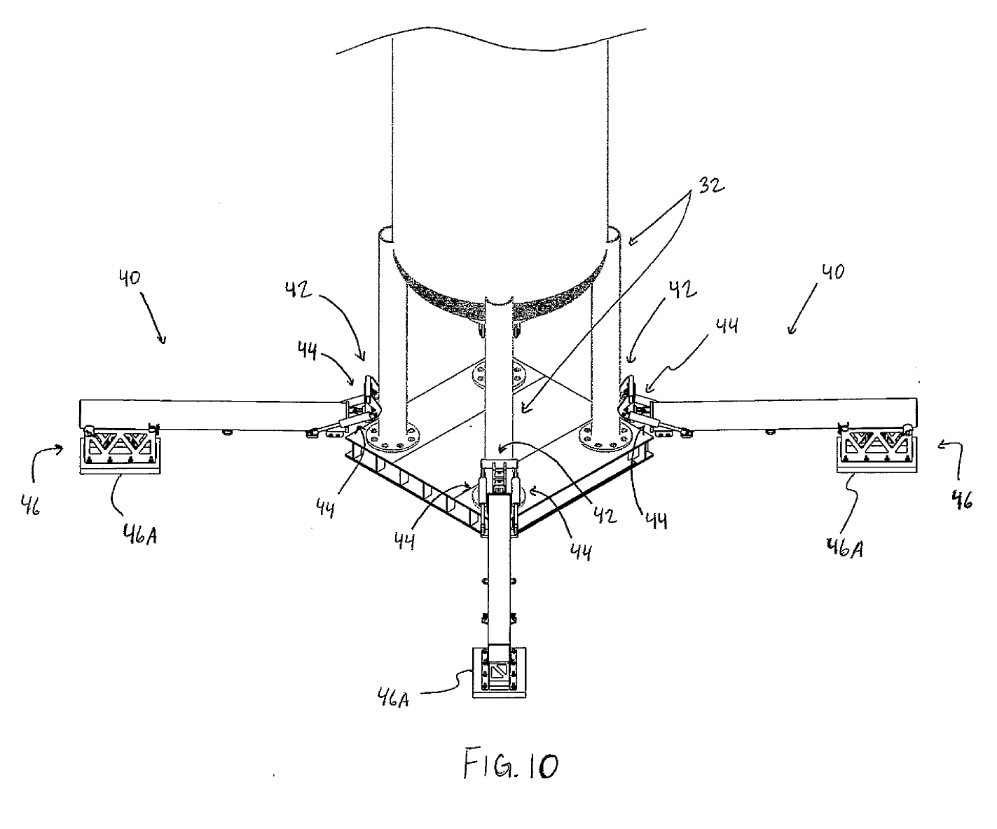

The support assembly also includes at least four stabilizer arms 40 which are connected to respective legs so as to be located at spaced positions around the base 36. Note that in other embodiments, the stabilizer arms may be connected to the base. In a first embodiment of the stabilizer arms more clearly illustrated in FIGS. 9-10, the stabilizer arms are hydraulically actuated. In the first embodiment, each stabilizer arm is mounted on a pivot bracket 42 so that each stabilizer arm is movable by pivotal movement about a horizontal axis into a first retracted position as in FIG. 9 in which the stabilizer arm is raised from the base vertically upwardly so as to be located inside the circular outer periphery for transport with the tank body. Furthermore, each stabilizer arm is movable to a second extended position as in FIG. 10 in which the stabilizer arm extends outwardly to a respective side of the base for engaging the ground surface outwardly of the base while the base sits on the ground surface for stabilizing the base against tilting. In the second extended position as illustrated in FIG. 10, each stabilizer arm is radial to a central vertical axis of the base. A set of hydraulic stabilizer arm actuators 44 are coupled between the pivot bracket and each stabilizer arm. Each stabilizer arm also includes a stabilizing pad assembly 46 detachably coupled at a location along the stabilizer arm that is adjacent an outer end of each stabilizer arm. The stabilizing pad assembly has a stabilizing pad 46A which is substantially flat and rectangular in plan view. As such, the stabilizing pad defines a ground engaging surface of each stabilizer arm. Each stabilizing pad assembly is detached from each, stabilizer arm before transportation of the portable storage tank in the transport position.

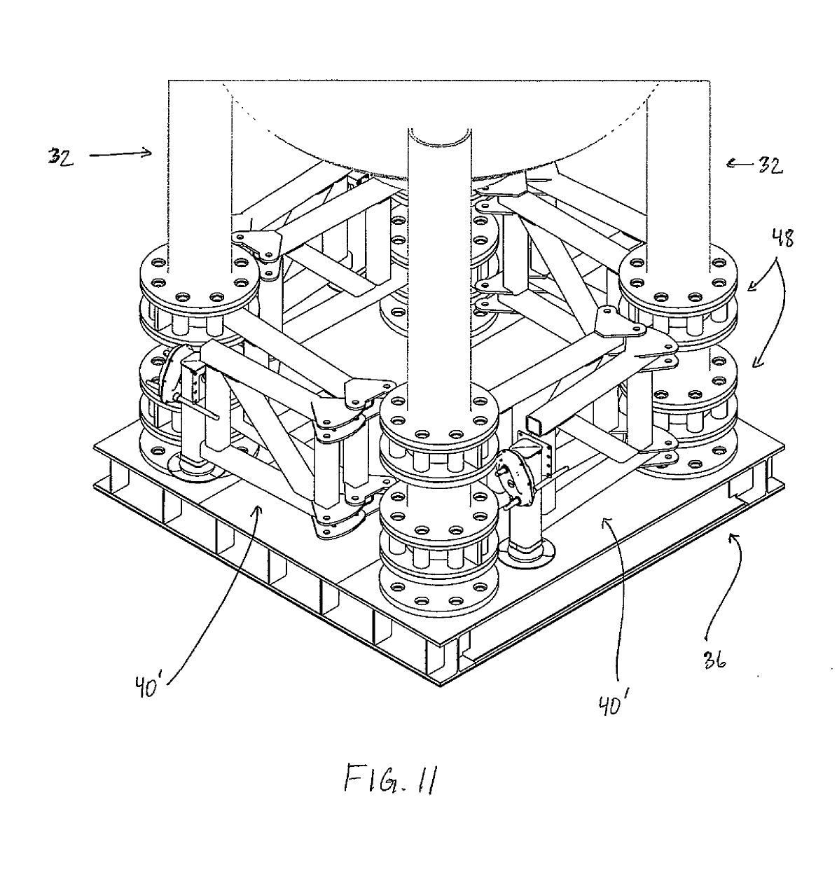

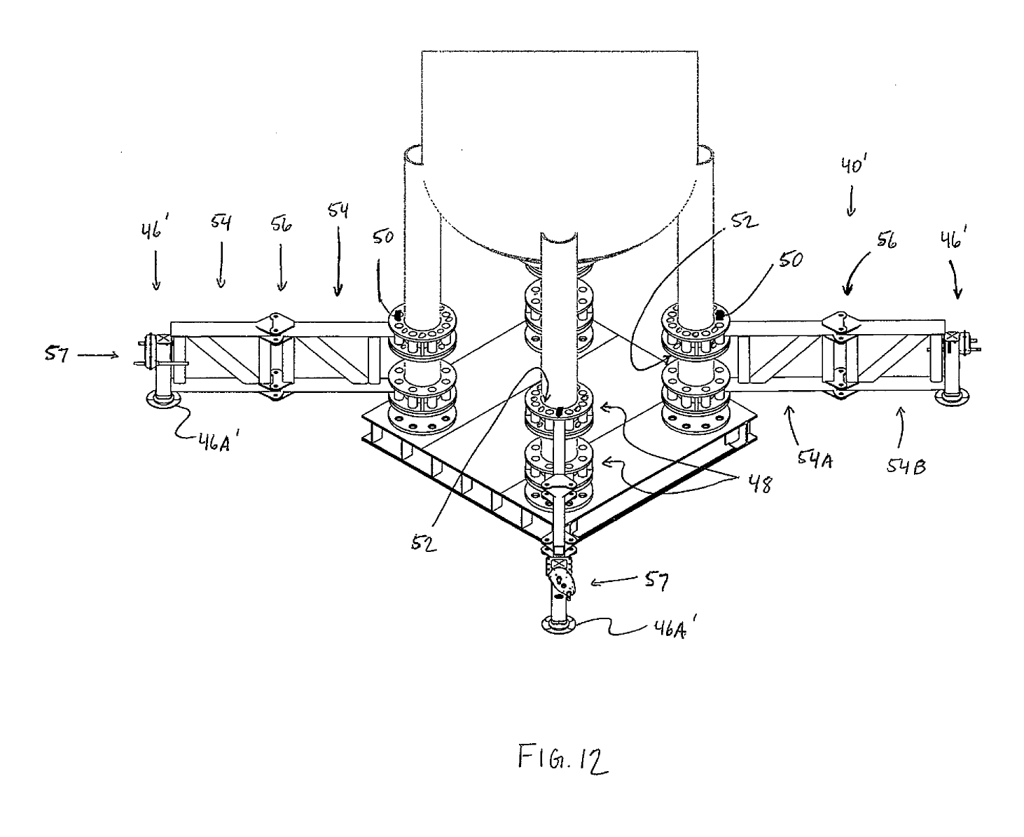

In a second embodiment of the stabilizer arms, the stabilizer arms are manually actuated. In the second embodiment illustrated in FIGS. 11-12, each stabilizer arm 40′ is mounted on ring-shaped couplers 48 so that each stabilizer arm is movable by rotational movement about an upstanding axis defined by each leg from the retracted position as in FIG. 11 in which each stabilizer arm is rotated horizontally inwardly so as to be located inside the circular outer periphery for transport with the tank body. Each stabilizer arm is movable to the second extended position as in FIG. 12 in which each stabilizer arm is rotated horizontally outwardly so as that the stabilizer arm extends outwardly from the base as described of the hydraulically actuated stabilizer arms. Each stabilizer arm 40′ is movable about its respective upstanding axis such that an angle of the stabilizer arm around the base is adjustable. As such, each stabilizer arm is movable from a position in which the stabilizer arm is radial to the central vertical axis of the base and is movable through an angle of at least 90 degrees from a first position in which the stabilizer arm is parallel to a stabilizer arm on one side to a second position in which it is parallel to a stabilizer arm on the other side. The stabilizer arm is secured in its position by a pin 50 inserted through correspondingly aligned holes 52 of the ring-shaped couplers. Furthermore, each stabilizer arm comprises sections 54 which are foldable at an elbow 56 that joins each of the sections. The elbow allows the sections to be folded about an upstanding axis which is substantially parallel to the upstanding axis defined by the respective leg. As such, the sections substantially overlap one another in the first retracted position so as to be stored within the outer peripheral edge defined by the base. Furthermore, each one of the sections has a section length measured generally between the elbow and an opposing end of the section; for example, in the illustrated embodiment the section length of an inner section 54A is generally measured between the ring-shaped coupler 48 and the elbow 56, and the section length of an outer section 54B is generally measured between the elbow and a free end of the outer section which has a stabilizing pad assembly 46′ similar to the embodiment of the hydraulically actuated stabilizer arms. As such, the section length of each section is shorter than a spacing between adjacent legs along the outer peripheral edge defined by the base so that each arm can be stored within the outer peripheral edge as illustrated in FIG. 11. Turning to the stabilizing pad assembly of the manually actuated stabilizer arms, the stabilizing pad 46A′ of the manually actuated stabilizer arm is substantially disc-shaped in plan view. The stabilizing pad is arranged to be movable vertically upwardly and downwardly by a crank 57 which is manually actuated.

The trailer 11 for loading, transporting, and erecting the portable storage tank comprises a frame 58 and wheels 60 rotatably supported on the frame. The frame extends longitudinally between opposing front and rear ends. The frame extends laterally between laterally opposing side members which span between the front and rear ends of the frame. The side members are braced by cross members of the frame that span laterally between the side members at spaced longitudinal locations along the frame. Furthermore, the frame comprises a hitch at or adjacent the front end of the trailer for coupling to a working vehicle such as a semi-truck. The wheels of the trailer are arranged in pairs which are longitudinally spaced along the trailer closer to the rear end of the trailer than to the front end thereof.

Further to the frame and wheels, the trailer comprises a bed portion 62 which is pivotally supported on the frame and which is arranged to support the portable storage tank thereon during transportation. The bed portion of the trailer is arranged for pivotal movement about a lateral axis at the rear end of the frame so that the bed portion is movable between a transport position in which the bed portion is substantially horizontal and overlapping the frame and an erecting position in which the bed portion is substantially vertical and upright relative to the frame. The bed portion extends longitudinally between front 62A and rear 62B bed ends. The front bed end is rearward of the hitch such that the front bed end is adjacent thereto. The bed has laterally opposing bed side members which span between the front and rear bed ends. The side members of the frame are substantially overlapped by the bed side members in the transport position of the bed portion. Furthermore, the trailer includes an erecting actuator coupled between the frame and bed portion that is arranged to move the bed portion between the transport and erecting positions. The erecting actuator comprises an upright erecting member 64 arranged to provide movement of the bed portion between the transport position and an intermediate position which is pivotally intermediate between the transport and erecting positions; an angle of pivotal movement between the intermediate and erecting positions is larger than an angle of pivotal movement between the transport and intermediate positions. The upright erecting member is located closer to the front end of the frame than to the rear end thereof. The upright erecting member is oriented generally upright relative to the frame. The upright erecting member comprises a plurality of telescoping elements which are elongate and slidable relative to one another in telescoping configuration. A first one of the telescoping elements defines a base of the upright erecting member that is coupled to the frame and extending generally upwardly therefrom. A second one of the telescoping elements is received in the first telescoping element and extends generally upwardly therefrom. A third one of the telescoping elements is received in the second telescoping element and extends generally upwardly therefrom. A fourth one of the telescoping elements is received in the third telescoping element and comprises a support pad 66 which presses upwardly against the bed portion. The upright erecting member lifts the bed portion to the intermediate position of the bed portion. The erecting actuator further comprises a pair of (hydraulic) cylinders which are arranged to move the bed portion between the intermediate and erecting positions.

The bed portion includes grapple arms 68 which are located at opposing lateral sides of the bed portion. The grapple arms are closer to the front bed end 62A than to the rear bed end 62B. The grapple arms are spaced forward of the rear bed end at a distance proximate the spacing between the radial planes in which the handles lie and in which the base lies. The grapple arms are arranged to cooperatively hook onto the handles 26 at the periphery wall of the tank body for securing it to the trailer. The grapple arms are movable between a holding position in which the grapple arms are hooked onto respective ones of the handles and a released position in which the grapple arms are separated from the handles. The grapple arms extend further laterally outward in the released position than when in the holding position. As such, each grapple arm comprise a tubular member 70 and a hooking member 72 which is substantially received in the tubular member and slidable relative thereto. The hooking member has a hook portion 74 at an outer end thereof which is arranged for hooking onto the gripping element 30 of a respective one of the handles. Each one of the grapple arms is arranged for pivotal movement between the holding and released positions about an axis parallel to a longitudinal axis of the trailer at a located spaced laterally outward from the frame. Accordingly, each grapple arm has a pair of actuators which are arranged to move each one of the grapple arms between the holding and released positions. A first one 76 of the actuators extends between the bed portion and the tubular member of its corresponding grapple arm and is arranged to pivot the corresponding grapple arm laterally inwardly or outwardly for aligning the hooking member with the respective one of the handles of the portable storage tank. A second one 78 of the actuators, which lies along the tubular member and extending between the tubular member and the hooking member, is arranged to slide the hooking member inwardly into or outwardly out of the tubular member for hooking the hook portion onto the gripping element of the respective handle.

The bed portion also has protruding elements 80 at the rear bed end 62B that are laterally aligned with the openings 38 in the base of the portable storage tank when the storage tank is loaded onto the trailer. The protruding elements are spaced laterally across the bed portion so as to be inserted into the openings of the base and effect an interlocking action therewith for supporting and holding the portable storage tank substantially in fixed relation to the bed portion when loading and erecting the storage tank. Each one of the protruding elements comprises a base engaging surface 80A which defines a load supporting surface of the trailer for supporting the base when loading and erecting the portable storage tank. The base engaging surfaces are substantially flat and arranged to press on the base generally upwardly from within the openings of the base. In the illustrated embodiment, the protruding elements are generally wedge shaped. Further to the protruding elements, the bed portion has a recessed portion 82 at the rear bed end 62B. The recessed portion is forward of the protruding elements and rearward of the grapple arms so as to be closer to the protruding elements than to the grapple arms. The recessed portion is recessed relative to a portion of the bed portion forward of the recessed portion so as to receive an edge 84 of the upper surface of the base therein when the portable tank is secured to the bed portion so that the longitudinal axis of the tank body is substantially horizontal and parallel to the longitudinal axis of the trailer in the transport position. The recessed portion also helps maintain the portable tank in fixed relation to the trailer during transport.

In use, the portable storage tank 10 is loaded in a substantially horizontal position onto the trailer 11, with the stabilizer arms 40 in the first retracted position, for transporting to the well site. The grapple arms 68 are moved into the holding position so as to secure the portable storage tank to the trailer. Movement into the holding position comprises moving the grapple arms laterally inwards towards the frame of the trailer so as to align each grapple arm with the respective handle 26 of the portable storage tank and moving the hook portions of the grapples arms so as to hook onto the gripping elements of the handles. Once the portable storage tank is supported substantially horizontally on the trailer, a plurality of straps are used to further secure the portable storage tank to the trailer.

Once transported to a destination, the portable storage tank is erected. The process of erecting the tank involves moving the bed portion 62 of the trailer into the erecting position, at which stage the portable storage tank is generally upright and generally rearward of the trailer and the base is over and adjacent the ground. Then, the grapple arms are moved into the released position such that the tank is separated from the trailer. Movement to the released position from the holding position comprises moving the grapples arms laterally outward away from the tank body and moving the hook portions 74 such that the hook portions are unhooked from the gripping elements 30 of the handles. Next, the trailer is moved forward away from the trailer so that the protruding elements 80 of the bed portion are removed from within the openings 38 of the base of the portable storage tank.

With the portable storage tank erected, the stabilizer arms 40 can be moved from the first retracted position into the second extended position so as generally stabilize the tank body relative to the ground surface. Then, a pressurized liquid or gas to be stored in the portable storage tank can be pumped therein.

The portable storage tank can be loaded back onto the trailer by reversing the erecting process for relocating the storage tank.

Note that in other embodiments of the portable storage tank, already manufactured pressure tanks or vessels, which conform to size restrictions of road transportation by trailer and comprise a tank body and legs extending downwardly from the tank body, are retrofitted to produce the portable storage tank of the illustrated embodiment through addition of the base, stabilizer arms, and handles.

Also, in another embodiment the stabilizer arms of the support assembly are connected to the base. Each stabilizer arm is mounted on a first pivot bracket like the pivot bracket in the aforementioned embodiment of the hydraulically actuated stabilizer arms. Furthermore, each stabilizer arm is mounted on a second pivot bracket so as to be movable about an upstanding axis at the base that is parallel to the longitudinal axis of the tank so as to move the stabilizer arm so that the angle of the stabilizer arm around the base is adjustable as in the second illustrated embodiment of the stabilizer arms. Additionally, each stabilizer arm includes a brace extending from the base at a top pivot point at a leg to a bottom pivot point at the arm, the brace being movable from a position lifting the stabilizer arm to the retracted position to the position extending downwardly and outwardly to locate the stabilizer arm in the extended position. In order to effect this motion, the brace includes an elbow allowing the brace to be folded at the elbow by an actuator or hydraulic cylinder extending along the brace from the upper end to a crank at the elbow for driving folding of the brace to effect movement of the stabilizer arm. The upper end of the brace is also mounted on a third pivot bracket aligned with the second pivot bracket and defining the common upstanding axis therewith so that both the brace and the stabilizer arm pivot around the upstanding axis to provide the angular adjustment of the stabilizer arm.

Since various modifications can be made in my invention as herein above described, and many apparently widely different embodiments of same made, it is intended that all matter contained in the accompanying specification shall be interpreted as illustrative only and not in a limiting sense.

1. A method for storing a pressurized liquid or gas comprising:
arranging a portable storage tank for storing the pressurized liquid or gas therein, the portable storage tank comprising:
a tank body arranged to contain pressurized liquids or gases therein, the tank body having a periphery wall defining a circular outer periphery of the tank, an upper wall at a top of the tank, and a lower wall at a bottom of the tank;
openings at or adjacent the top and bottom of the tank body for filling said liquid or gas therein and discharging said liquid or gas therefrom;
a support assembly for resting on a support surface, the support assembly being arranged such that respective ones of the openings at or adjacent the bottom of the tank body are raised relative to the support surface for discharge into a receptacle at the support surface;
the support assembly including a plurality of legs extending downwardly from the tank body;
the support assembly further including a base arranged for resting on the support surface to support the tank body standing upwardly from the support surface;
loading the portable storage tank in a substantially horizontal position onto a trailer for transporting the portable storage tank;
erecting the portable storage tank; and
filling the pressurized liquid or gas into the portable storage tank.

2. The method according to claim 1, wherein the portable storage tank further comprises a plurality of handles at the periphery wall that are arranged to be hooked cooperatively with the trailer for securing the tank body to the trailer during transportation and when loading and erecting the tank body.

3. The method according to claim 2, wherein the handles are coupled to an outer surface of the periphery wall.

4. The method according to claim 1, wherein the trailer comprises a bed portion arranged to support the portable storage tank thereon, the bed portion also being arranged to be movable between a transport position in which the bed portion is substantially horizontal and an erecting position in which the bed portion is substantially vertical.

5. The method according to claim 4, wherein the bed portion is arranged for pivotal movement between the transport and erecting positions that is about an axis transverse to a longitudinal axis of the trailer.

6. The method according to claim 1, wherein the trailer comprises a bed portion arranged to support the portable tank thereon, the bed portion comprising a plurality of arms arranged to be cooperatively hooked with the tank body for attaching the tank body to the bed portion.

7. The method according to claim 1, wherein the base has openings along at least a portion of an outer periphery of the base that are arranged to be cooperatively interlocked with the trailer for loading and erecting the tank body.

8. The method according to claim 7, wherein said at least a portion of the outer periphery of the base comprises transversely opposing sides of the outer periphery of the base and the openings therein are generally rectangular.

9. The method according to claim 7, wherein the trailer has protruding elements at a rear thereof that are arranged to be inserted into the openings of the base of the portable storage tank.

10. The method according to claim 9, wherein at least one of the protruding elements comprises a base engaging surface arranged to press on the base generally upwardly from within one of the openings of the base.

11. The method according to claim 1, wherein the support assembly includes at least four stabilizer arms located at spaced positions about the base, each stabilizer arm being movable between a first retracted position in which said each stabilizer arm is located inside the circular outer periphery for transport with the tank body and a second extended position in which said each stabilizer arm extends outwardly to a respective side of the base for engaging the support surface outwardly of the base while the base sits on the support surface for stabilizing the base against tilting.

12. The method according to claim 11, wherein each stabilizer arm is movable between the first retracted and second extended positions about an upstanding axis defined by each leg.

13. The method according to claim 11, wherein each stabilizer arm comprises at least two sections which are foldable at an elbow of said each stabilizer arm that joins said at least two sections, the elbow allowing the sections to be folded thereat about an upstanding axis.

14. The method according to 13, wherein each one of the at least two sections of said each stabilizer arm has a section length, the section length of at least one of the at least two sections being less than a spacing between adjacent legs along an outer periphery of the base.

15. The method according to claim 11, wherein the stabilizer arms are connected to the legs.

16. The method according to claim 1, wherein the circular outer periphery has an outer diameter less than 15 feet so as to allow the tank body to be portable on the trailer.

17. The method according to claim 1, wherein the tank body is cylindrical along its full length.

18. The method according to claim 1, wherein each leg has a main portion and a mounting portion thereunder, the mounting portion extending radially beyond the main portion.

19. The method according to claim 18, wherein the mounting portions of the legs are bolted or welded to the base.

20. The method according to claim 1, wherein each leg is cylindrical along a majority of its length.
